(19) United States
(12) Patent Application Publication
(10) Pub. No.: US 2008/0063154 A1
(43) Pub. Date: Mar. 13, 2008

(54) System and method of customized event notification

(76) Inventors: Yossi Tamari, Ra'anana (IL); Gil Perez, Los Gatos, CA (US); Brian Willis, San Diego, CA (US); Amir Sadras, Tel-Aviv (IL); Tsafrir Oranski, New York, NY (US)

Correspondence Address: PEARL COHEN ZEDEK LATZER, LLP, 1500 BROADWAY 12TH FLOOR, NEW YORK, NY, 10036, US

(21) Appl. No.: 11/501,222

(22) Filed: Aug. 9, 2006

(51) Int. Cl. H04M 11/00

(52) U.S. Cl. 379/88.13

(57) ABSTRACT

A system and method to select from among various notification channels a notification channel over which to send event data and response options, such selection based on a stored preference of a recipient of the event data to receive event data on the selected notification channel.

### FIELD OF THE INVENTION

The present invention relates to communicating business event data, and particularly to selecting a notification channel over which to deliver data to a recipient based on pre-defined criteria of the recipient.

### BACKGROUND OF THE INVENTION

A decision maker in an organization such as for example a business, health care facility or other organization may receive a plethora of notifications of business events that may call for the recipient's response. Such notifications may originate from backend systems, collaboration tools, devices or sensors, or may be dynamically created by individuals in an ad-hoc fashion. Frequently they may contain less than all of the information necessary for making required decisions, and may be delivered over communication channels that are not available to an intended recipient at the time that a response to the event is needed Responses to events may thereby be delayed or altogether lost, resulting in inconvenience and lost productivity.

### SUMMARY OF THE INVENTION

In some embodiments, the invention includes a method of receiving event data, selecting from several electronic notification channels, a notification channel over which to send a message to a recipient, where the message includes at least a portion of the event data, and where the selecting is based on a stored preference of the recipient to receive the message on the selected notification channel at a designated time period; and generating the message in a format suitable for sending over the selected notification channel, and where the message includes an option for responding to the event data or the message.

In some embodiments, the method includes selecting based on a schedule having several time periods and a preferred notification channel associated with at least one of the time periods.

In some embodiments, the selecting is based on an indicator of the recipient s availability by the notification channel at the designated time period. In some embodiments, the indicator is selected from the group consisting of instant messenger (IM) status indicator, a computerized calendar of the recipient, contemporaneous computer use by the recipient, contemporaneous use of an electronic device linked to a network, and an activation status of a screen saver on a computer of said recipient.

In some embodiments, the method includes storing the message prior to the designated time period, and delivering the stored message during the designated time period.

In some embodiments, the method includes selecting a second notification channel over which to send the message to the recipient if a response to the message is not received from the recipient within a pre-defined response time period, and lo generating the message in a format suitable for the second notification channel.

In some embodiments, the method includes sending the recipient a message through two or more channels at once, and generating the messages in two formats suitable for delivery by each notification channel.

In some embodiments, the method includes receiving from the recipient a response from among the several possible response options.

In some embodiments, the method includes inserting into the message background information relevant to the event data or the decision to be made by the recipient.

In some embodiments, the method includes inserting into the message a link to background information relevant to the event data or the decision to be made by the recipient.

In some embodiments, the method includes selecting the notification channel based on a characteristic of the event data.

In some embodiments, the method includes selecting a second recipient to receive a second message if the first recipient does not respond to the first message in a pre-defined response time period or if an indication to delegate the message was otherwise received. In some embodiments, the indication to delegate is received from the first recipient.

In some embodiments, the invention includes a method of receiving event data, selecting from at least two electronic notification channels a first notification channel over which to send a first message to a recipient, such first message including a first portion of the event data, and such selecting based on a stored preference of the recipient to receive the first message on the first notification channel at a designated time period, generating the first message in a format suitable for sending over the first notification channel, selecting from such at least two electronic notification channels, a second notification channel over which to send a second message to the recipient, such second message including a second portion of the event data; and generating the second message in a format suitable for sending over the second notification channel. In some embodiments of the method, the first message includes an indication that the second portion of the event data is included in the second message.

### BRIEF DESCRIPTION OF THE DRAWINGS

Embodiments of the invention are illustrated by way of example and not limitation in the figures of the accompanying drawings, in which like reference numerals indicate corresponding, analogous or similar elements, and in which:

FIG. 1 is a conceptual diagram of a system to select a communication channel by which to transmit a message to a recipient based on a delivery preference of the recipient, in accordance with embodiments of the invention;

FIG. 2 is a conceptual illustration of a system to select a communication channel and evaluate a degree of availability of a recipient of a message by one or more communication channels, in accordance with an embodiment of the invention;

FIG. 3 is a conceptual illustration of a method in accordance with the present invention; and

FIG. 4 is a conceptual illustration of a system linking a user to one or more business processes in accordance with an embodiment of the invention.

It will be appreciated that for simplicity and clarity of illustration, elements shown in the figures have not necessarily been drawn to scale. For example, the dimensions of some of the elements may be exaggerated relative to other elements for clarity.

### DETAILED DESCRIPTION OF THE INVENTION

In the following detailed description, numerous specific details are set forth in order to provide a thorough understanding of embodiments of the invention. However it will be understood by those of ordinary skill in the art that the embodiments of the invention may be practiced without these specific details. In other instances, well-known methods, procedures, and components have not been described in detail so as not to obscure the embodiments of the invention,

Unless specifically stated otherwise, as apparent from the following discussions, it is appreciated that throughout the specification, discussions utilizing terms such as “processing,” “computing,” “calculating,” “determining,” or the like, refer to the action and/or processes of a processor, computer or computing system, or similar electronic computing device, that manipulates and/or transforms data represented as physical, such as electronic quantities within the computing system's registers and/or memories into other data similarly represented as physical quantities within the computing system's memories, registers or other such information storage, transmission or display devices.

The processes and displays presented herein are not inherently related to any particular computer, communication device or other apparatus. The desired structure for a variety of these systems will appear from the description below. In addition, embodiments of the present invention are not described with reference to any particular programming language, machine code, etc. It will be appreciated that a variety of programming languages, machine codes, etc. may be used to implement the teachings of the invention as described herein.

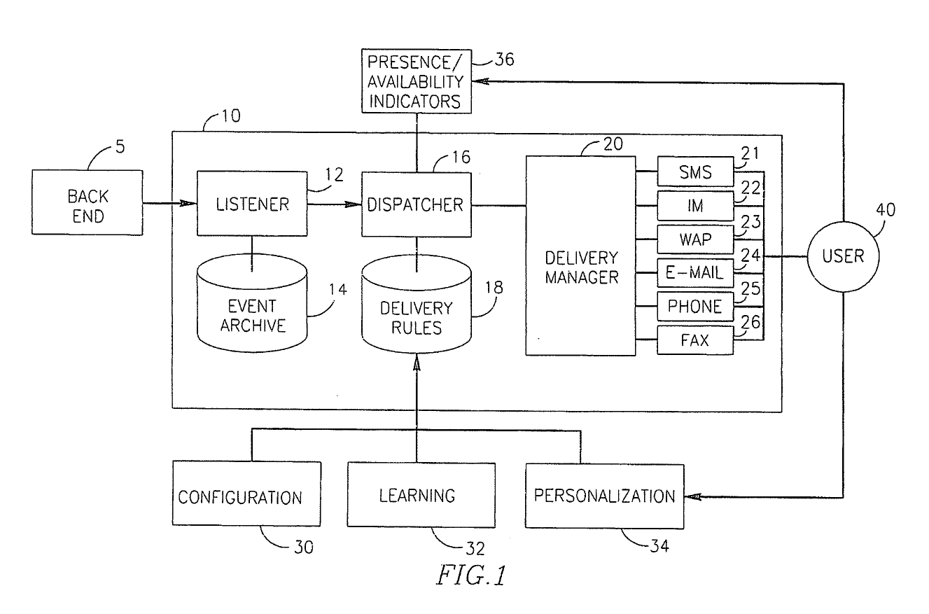

Reference is made to FIG. 1, a conceptual diagram of a system to receive event data and select a communication channel by which to transmit a message to a recipient based on a delivery preference of the recipient, in accordance with embodiments of the invention System 10 may receive notification of a business event from a back end 5 by means of listener module 12 Back end 5 may represent an outside source of information, such as for example an ordering system indicating that a customer order having a payable amount in excess of a permitted credit limit or a human resource (HR) system indicating that an employee has requested vacation. In some embodiments, the event may include data other than business data, such as for example data on a health status of a patient in a medical facility, current events, sports data or other data In particular, event archive 14 may be operatively connected to listener module 12 to store data about the incoming event.

Upon the identification of a business event, listener 12 may notify dispatcher module 16. In some embodiments, dispatcher module 16 may discard the event based on characteristics of the incoming event vis-à-vis data tables in delivery rules database 18 indicating which events to discard.

Dispatcher module 16 may receive notification of the business event and determine parameters relating to its delivery. Dispatcher module 16 may assess, for example, one or more characteristics about the event such as for example a time period wherein a response is needed to the event, the person or persons to be notified of the event, the channel and time for delivery of the event, and other parameters for notification of the event to the user or recipient.

Dispatcher module 16 may determine parameters for delivery based on delivery rules database 18. Delivery rules database 18 may be created and/or updated, for example, using input from any or all of administrator configuration 30, the system's self-learning function 32, for example, by feedback, and/or by user personalization 34 of delivery preferences. The delivery rules may provide data tables to determine various delivery parameters, including, for example, which recipient(s) are to be notified about various events, what method(s) of delivery or delivery channels are to be used for particular recipients, the time of delivery of the notification to the recipient, and other delivery parameters. The parameters may be based on one or more inputs including, for example, the characteristics, nature or priority of the business event, the time of day that the message is being delivered, the identity of the recipient, etc.

In its determination of the communication channel(s) over which to send a message having event data to a recipient, the dispatcher module 16 may receive input from one or more presence/availability indicators 36. Presence/availability indicators 36 may be real-time sensors indicating that a user is or is not present or available via a certain channel. Presence indicators 36 may also indicate the location of the user and/or his current occupational status, for example, if he is in a meeting or otherwise engaged and not to be disturbed.

The dispatcher module 16 may formulate a template that may include static information as may have been received in the original event data, or that may include dynamic content such as information added by for example the dispatcher module 16 that may be deemed helpful to the recipient in formulating a response to the event data notification. Preferably the template includes enough information about the event for the user to make a required decision. The template for the message may also preferably include options for responding to the message. The template may be filled in, for example, by data from the event archive 14, which may contain the information needed by recipient to respond to a business event, and a list of the information required by the system from the recipient to be provided in response to the notification.

In some embodiments, backend 5 may deliver event data and a list of one or more intended recipients of the data, as well as a list of possible responses or actions that are to be provided to the recipient to address the event data. In some embodiments, backend 5 may also provide a time period in which a response is needed from the intended recipient and a priority and/or characterization of the event described by the data.

Delivery manager 20 may contain or be operatively connected to delivery sub-modules for converting the template provided by the dispatcher module 16 into one or more messages in a format suitable for sending through the various channels, and for executing delivery of the message. The delivery sub-modules may include, for example, Short Message Service (SMS) module 21, Instant Message (IM) module 22, Wireless Application Protocol (WAP) module 23, Email module 24, phone module 25, fax module 26, and/or other modules. Delivery manager 20 may include or exclude information in the template of the message depending on the communication channel used. The delivery sub-module may execute delivery of the message to recipient or user 40.

In some embodiments, dispatcher 16 may upon consultation with delivery rules database 18, select a communication channel over which to deliver a message containing event data to recipient user 40. For example, dispatcher 16 might instruct delivery manager 20 to phone user 40 based on a set of personalized preferences 34 that may have been stored in delivery rules database 18, indicating that for example after regular business hours, user 40 wants to receive event data by telephone 25 to his mobile number. Delivery manager 20 or some other component may locate the mobile phone number of a user 40 in the user database (not shown), may generate a message that includes for example the relevant event data and one or more response options, and may manage the transmission of the message.

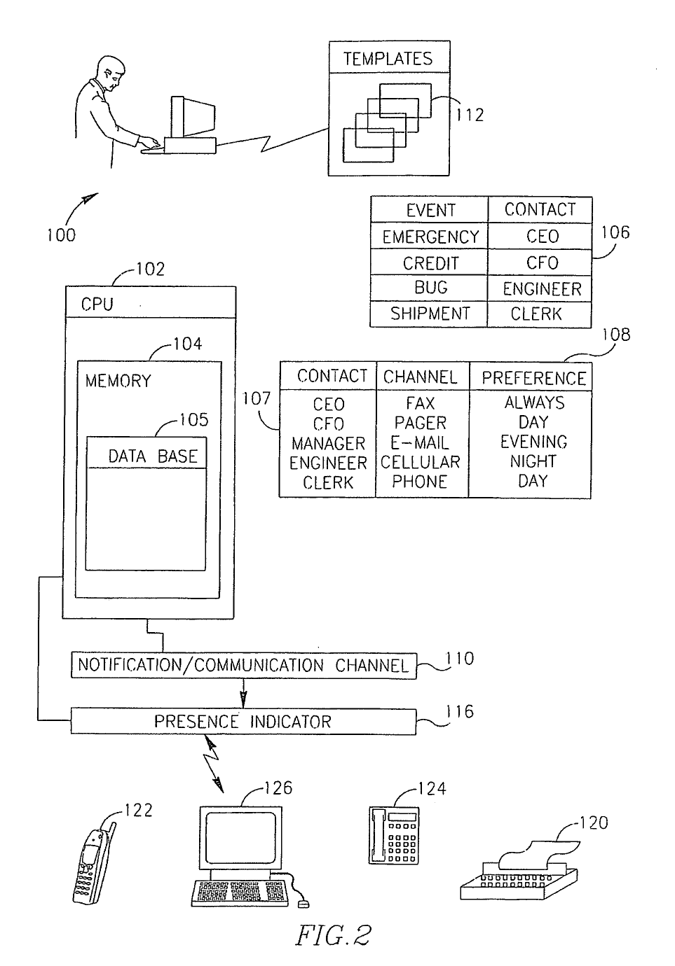

The system of FIG. 1 is further refined in an example of an embodiment of the system depicted in FIG. 2, a conceptual illustration of a system to categorize an event, assemble data and possible responses into a message, and select a notification channel for such message using pre-defined criteria. It will be understood that the elements of FIG. 2 may include or overlap with elements of FIG. 1; however, in order not to limit the scope of the invention, different numbering has been used.

In some embodiments, data relating to an event may be used to generate for example an alert over a network that may be received by a system 100. In some embodiments, an event may be for example an externally initiated event, such as a movement of a price of a product or a security or a health related event of a patient. In another example, a business event may trigger a need for a response or decision from a decision-maker, such as for example, a vacation request from an employee to his boss. In some embodiments, data about the event may be received by system 100 that may for example include a processor 102 such as a central processor and a memory 104. Data about the event may be stored in memory 104, and categorized or ranked by importance relative to, for example, a series of pre-defined criteria that may have been entered into a data base 105. It will be recognized that data base 105 need not be separate, but may be included or associated with memory 104. Data about the event may in some embodiments be stored in data base 105.

In operation, for example, a movement of a price of a product, commodity or security may be considered an event, and an extent of a movement may be ranked as more or less important on the basis of for example the percentage movement of the security, where a large movement in price may be very important and may be ranked with a 90 out of 100 on an importance scale, while a small movement may be ranked 10 out of 100 on the importance scale. Similarly, a fire in a factory may be ranked 100, while a receipt of a shipment may be ranked 10. Other rankings or categorizations and other events may be used. It will be understood that the priority ranking of business events may be individually configured for each system, for example, by an administrator setting up the system. Alternately, a user may provide an individual ranking system for items relevant to that user, or event data may include an importance ranking.

In some embodiments, a template 112 for a message to convey data about an event may be generated by system 100, and the template 112 may include data about the event, background data that may be relevant to a decision-maker's actions or decision relating to the event, and one or more possible actions that a decision maker may select as a response to the event. In some embodiments, one or more layers of data, such as background data that may be stored in for example a data base 105, may be included in or made available through template 112. For example, a patient history may be stored in data base 105, and a message that includes event data about the patient may include for example a medical history of the patient or for example a link that may provide access to the medical history. Similarly, a purchase request by a customer may be a subject of an event, and a credit history of the customer may be included in the template 112 or made available in for example a link that is included or made available in the message. In some embodiments, data about the event may include contextual information such as for example the number of times a similar situation has occurred, the responses provided to such similar situation in the past, and past results or other reactions of such responses. For example, an event that includes a large order of a product may include a request for an increase in a credit limit. For example, the message that may be generated may provide a recipient with data on a payment history of the customer, or an ordering history including relevant parameters.

In some embodiments, system 100 may package data about an event in a template 112 or other format that may match or be suited to the data describing the event. For example, the credit approval request may be included in a template 112 that has a yes or no as a response option. It will be understood that other formats or templates are possible, and various possible responses to the message may be included in the message and generated by system 100.

In some embodiments, a characteristic, nature or ranking of the data that is received may influence or be evaluated as part of a decision on the identity of a recipient of the message of the communication channel by which the message is to be delivered.

Data base 105 may include various data tables. It will be understood that tables 106, 108 and 107 depicted in FIG. 2 are figurative representations and may contain more or fewer fields and parameters than shown. As an example, in one embodiment of the invention, data base 105 may include table 106 with subscription data pairing types of events with names of possible recipients of messages about the event. Recipients may be able to subscribe or unsubscribe from receiving messages about events. For example, an executive of a company may request that he be informed only of emergencies such as a fire at a company facility. A less senior executive may be sent messages about issues such as those reflecting credit decisions or sales prices, and still other employees may elect to be informed about customer complaints with a particular product. In some embodiments, events may be divided into categories in addition to or instead of types, so that a recipient may receive notification of movements in the price of a stock price in the oil industry but not of stocks in the communication industry. Other possible ways to or classify events are possible.

In some embodiments, subscription table 106 may limit the recipients that may receive a message to a particular list, based on for example a set of access, security, authorization or other rules.

In some embodiments, processor 102, or another processor, may refer for example to table 108, a list or array that may include one or more notification channels and one or more preferences of recipients 107 for use of the notification channels. For example, an administrator or an individual recipient may create a list of preferences indicating that data to be delivered during work hours should be sent by email while data sent after work hours should be sent by fax to his home, or for example by short message service (SMS) or instant messenger (IM) or pager. System 100 may refer to the preferences of the particular recipient 107 in table 108 and notify recipient 107 on the preferred notification channel, taking into account the time of day or other criteria indicated in table 108 as a basis to select the notification or communication channel 110.

In some embodiments, table 108 may have more or fewer columns to allow a person such as a recipient 107 to select a particular communication channel 110 at particular times of day, or to express various preferences to receive certain messages over a first communication channel and other messages over a second communication channel.

In some embodiments, system 100 may select a communication channel 110 based on the highest, or most important raining that was assigned to the event. For example, if an event is ranked as extremely important, the communication channel 110 designated to carry extremely important events will be selected by for example a recipient or for example a system administrator as the first communication channel 110 over which to send the data so that the communication channel 110 at the top of the recipient's hierarchy is selected as the one upon which the most important messages are sent to him. In some embodiments, each user or recipient may select and customize a delivery profile to include for example the delivery channels he prefers to use in one or more times of day and for one or more importance levels.

For example, a first table 106 may designate that an executive is to be alerted only in an event of emergency such as for example a fire. A second table 108 may indicate that the same executive wants to receive his messages by fax 120 to his home. An interaction of table 106 and table 108 may indicate that the executive wants to receive an alert of emergencies by fax to his home. It will be understood that other combinations of factors or criteria that may be used or considered in selecting a recipient and a notification channel 110 are possible. Other combinations of preferences may be included in a delivery preference list or table for one or more users.

In some embodiments, a message or notification of an event may include one or more response choices. For example, a business event that may be transmitted to an employee may include a list of possible actions from which the recipient may choose in response to the event. In some embodiments, the responses may be selected from a pre-defined list of alternatives that may be associated with the event. For example, a list of shipping possibilities for a rush shipment may be transmitted along with event data to give the employee likely choices from which to respond. The recipient may then respond to the system 100 with the response chosen, either via the same channel of notification, or via another channel. For example, the system 100 may send a message to a recipient by SMS, and request that the recipient respond by sending back a preferred shipping method for a delivery. The system 100 may include various possible responses from which the recipient may choose. The recipient may respond to the message by for example SMS or may elect to respond via another communication channel, such as for example by telephone. In some embodiments, authentication information such as a password or voice recognition identification may be collected from a responding recipient before action is taken on the response.

In some embodiments, system 100 may assemble a collection of data about an event, and deliver a part of such data over a first notification channel 110, and a second part of the data over a second notification channel 110. For example, a part or segment of event data may be sent by SMS—a channel which typically does not allow for elaborate messages—to a particular user along with a request for an immediate response, while the rest of the event notification, including further background data and an expanded question or response request, may be delivered by for example email. In some embodiments, the notification over the first channel may include reference to the message delivered over the second channel, thereby notifying the recipient to retrieve the detailed message delivered over the second channel.

In some embodiments, a recipient may select a hierarchy or other ordering of notification channels 110 to be used by system 100 depending on the event. For example, a recipient 107 may desire that a message about an emergency occurring during non-work hours first be sent to a fax 120 or email 126 to his home. The system 100 may monitor for a response to the message, and if recipient does not respond to the delivered message within a predetermined time, for example, two hours, the system 100 may reissue the message on another channel, for example, via SMS to a mobile phone 122. This process may be repeated for other channels until the recipient responds. Thus, in this example, if the recipient does not respond within another hour to the SMS message the system 100 may call the recipient on home phone 124. In some embodiments, if a response is not received to a message from a first user within a pre-defined period, the system 100 may refer to a back-up recipient and direct the message to the backup recipient.

In some embodiments, system 100 may resend messages based on other criteria For example, messages to which the recipient has not responded at the end of a working day, may be sent or resent via a different notification channel 110, or to another recipient. Messages sent or resent in this manner may be ranked for importance or categorized based on pre-defined criteria. In some embodiments, data on the most important events may be sent in a first batch, for example at the end of a day over a high-priority notification channel 110 such as a cell phone or SMS. Data about less important events may be sent by email or a lower priority notification channel 110.

In some embodiments, a user delivery profile may indicate that the user wants to receive some or all of his messages at an end of a day or beginning of a next day. System 100 may collect or store the event data or messages until the selected time, and then deliver the stored messages that were received over a period of time to the recipient.

In some embodiments, system 100 may record the answering and response habits of a user, and may alter or modify preferences of the user in consideration of such habits. For example, system 100 may record that a user logs on to his emails at around 11 PM on week-nights and at midnight on weekends. In consideration of that schedule, system 100 may save the user's messages from the period between when the user left work in the evening, until the 11 log on time on weekdays and the midnight log on time on weekends. Other learning methods and recording techniques are possible.

In some embodiments, system 100 may select a notification channel 110 based on presence or availability indicators. Such indicators may indicate the location of a recipient 107 or a presence or proximity of recipient 107 to a particular notification channel 110. For example, system 100 associated with an IP telephony network may determine that a recipient 107 is speaking on the telephone 124 in his office. In another example, system 100 associated or connected to a LAN or other network, may determine that a user 40 is typing or moving a mouse on his office computer 126, or is navigating pages on the Internet. In yet another example, system 100 may detect that a screen saver on the computer in an office of recipient 107 is or is not activated as an indication that a user 40 is or is not at his desk. In another example, the system 100 may determine whether applications open on a user's computer, for example, conferencing applications such as WebEx or NetMeeting, indicate the user is participating in an online meeting. In another embodiment, the IP address, MAC address, subnet mask, DNS address or other network statistic of a user's computer may provide information about whether the user is at the office, at home, working while traveling abroad, and if so, in what country. In another embodiment, a route of packets over for example a cellular network may be used to determine a user's location in the world. In some embodiments, system 100 may track a location of a user or recipient over for example a GPS system, and may select a communication channel over which to deliver a message based on the location of a user. In another embodiment, the system 100 may extract the computer's clock or time zone. The presence indicators may be detected and provided to the system 100 by an application that may be installed on the user's computer. A presence indicator may run on a mobile device such as for example a cellular phone that may indicate a location of a user.

Based on such presence indicators 116, system 100 may select a notification channel 110 that is directed to recipient 107 at his current location, such as an instant message to his office computer, a telephone call to die office phone, etc.

In some embodiments, system 100 may access an electronic date book or calendar or other indication of where a recipient is, and on that basis may select an SMS as a notification channel to send a message to a recipient 107 who is then in a meeting. Similarly, system 100 may detect, for example, based on a user's computer calendar or though another location coordinator, a preferred means of notifying the recipient of a message to minimize a disruption of a user at inconvenient times.

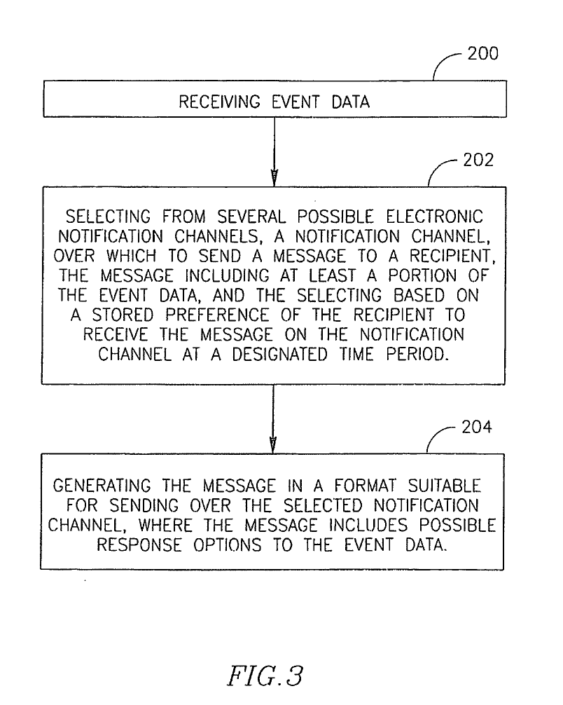

Reference is made to FIG. 3, a flow diagram of a method in accordance with an embodiment of the invention. In block 200 a system or component of a system may receive data about the occurrence of an event. In block 202, the system may select a notification channel to deliver a message that includes some or all of the received information. Such selection may be made from among more than one possible electronic notification channels, such as telephone, instant message (IM), short message service (SMS), wireless application protocol (WAP) push, fax, email or others. The system may prepare a message that includes the data or information, and may select the notification channel over which to send the message based on a delivery profile or set of preferences of a user or recipient. The delivery profile or user preferences may include one or more time periods, and a preferred notification channel to be used for messages in such time periods.

In block 204, the system may generate a message in a format that is suitable for sending over the selected notification channel. In some embodiments, the message may include an instruction to the recipient as to a plurality of possible response options that can be taken.

In some embodiments, the selecting of a notification channel may be based on a schedule of time periods and a preferred notification channel associated with one or more of the time periods on the schedule.

In some embodiments, the selection of a notification channel may be based on a user's preference to receive one or more of his messages when he is available on the notification channel. For example, a user may prefer to receive his messages for the preceding day, at the end of the day when he for example logs onto his computer at home, or when lie turns on his cell phone in his car.

In some embodiments, a system may store one or more messages into one or more batches and deliver the messages at a particular time that is later than the time when the data for such messages was received.

In some embodiments, a system may select a second or back up channel over which a message may be delivered if a response is not received from a recipient within a pre-defined time. The system may generate the message into the format of such as second communication channel.

In some embodiments, in response to an answer from a recipient to a message that may include event data, the system may invoke a web service call, invoke a function call, or request a resource via HTTP or HTTPS. In some embodiments, such action may transfer information to a work flow engine or an enterprise resource management (ERP) system. For example, the system may provide a response from a user to a work flow system, and such response may close off a work flow loop in such system or execute another action on such work flow engine, thereby allowing a work flow step to be advanced.

In some embodiments, a message may include a link to background information that may be relevant to the decision to be made in response to the message.

In some embodiments, a system may select a notification channel by at least one indicator of an availability or presence of the recipient to a notification channel at a particular time. In some embodiments, the availability or presence indicators may include for example a computerized calendar of a recipient, contemporaneous computer use by a recipient, contemporaneous use of an electronic device linked to a network, a time zone of a recipient, and an activation status of a screen salter on a computer of a recipient. Other availability or presence indicators are possible.

In some embodiments, a first portion of a message may be sent over a first notification channel and a second portion of the message may be sent over a second notification channel. For example, a first portion of the message, that may include for example basic data, may be sent by SMS. A second portion of the message that may include for example a PowerPoint presentation on the issue may be sent by email.

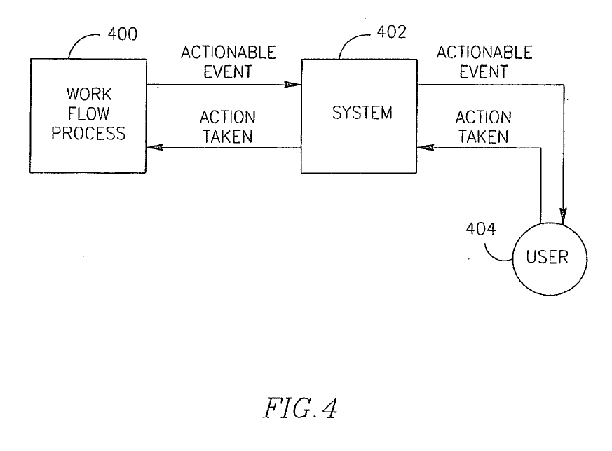

Reference is made to FIG. 4, a conceptual illustration of a system linking a user to one or more business processes in accordance with an embodiment of the invention. In some embodiments, a business process 400 such as for example a work flow process, an enterprise resource management system or other business decision system, may include or call for decisions to be made at various times by various parties, where for example a decision that may be called for from a first decision maker may determine an input or data provided to a next decision maker. A system 402 in accordance with some embodiments of the invention may accept data or a message that may include or be an indication of an event that may call for an action or decision to be made by a user 404. System 402 may transmit data about the actionable event over a selected communication channel to user 404. The user 404 may take an action, such as for example a decision, and may transmit data or an indication of the action back to system 402. System 402 may transmit data or an indication of the action taken back to the business process 400, where the action taken may trigger further actions or responses in the business process.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the spirit of the invention.

1. A method comprising:
receiving event data;
selecting from a plurality of electronic notification channels, a notification channel over which to send a message to a recipient, said message including at least a portion of said event data, said selecting based on a stored preference of said recipient to receive said message on said notification channel at a designated time period; and
generating said message in a format suitable for sending over said notification channel, said message including a response option to said event data.

2. The method of claim 1 wherein said selecting comprises selecting based on a schedule having a plurality of time periods and a preferred notification channel associated with a time period of said plurality of time periods.

3. The method of claim 1, wherein said selecting comprises selecting the notification channel by at least one indicator of an availability of said recipient to said notification channel at said designated time period.

4. The method of claim 3, wherein said indicator is selected from the group consisting of a computerized calendar of said recipient, contemporaneous computer use by said recipient, contemporaneous use of an electronic device linked to a network, and an activation status of a screen saver on a computer of said recipient.

5. The method as in claim 1, comprising:
storing event data prior to said designated time period; and
delivering said message during said designated time period.

6. The method as in claim 1, comprising:
selecting a second notification channel over which to send said message to said recipient if a response is not received from said recipient within a pre-defined response time period; and
generating said message in a format suitable for said second notification channel.

7. The method as in claim 1, comprising receiving from said recipient a response.

8. The method as in claim 7, comprising executing an action based on said response.

9. The method as in claim 8, wherein executing an action comprises executing an action selected from the group consisting of executing a web service call, invoking a function call, requesting a resource via HTTP and requesting a resource via HTTPS.

10 The method as in claim 8, wherein said executing an action comprises transferring information to a work flow engine.

11. The method as in claim 7, wherein said receiving comprises receiving said response over a channel selected from the group consisting of telephone, instant messaging (IM), facsimile, short message service (SMS), email, HTTP, HTTPS and wireless application protocol (WAP).

12. The method of claim 1, wherein said message includes background information relevant to said event data.

13. The method as in claim 12, wherein said message includes a link to background information relevant to said event data.

14. The method as in claim 1, wherein said selecting comprises selecting said notification channel based on a characteristic of said event data.

15. The method as in claim 1, comprising selecting a second recipient to receive a second message if said a recipient does not respond to said a message in a pre-defined response time period.

16. The method as in claim 1, wherein said selecting from a plurality of notification channels comprises selecting from the group consisting of telephone, instant messaging (IM), facsimile, short message service (SMS), email, HTTP, HTTPS and wireless application protocol (WAP).

17. A method comprising:
receiving event data;
selecting from a plurality of electronic notification channels, a first notification channel over which to send a first message to a recipient, said first message including a first portion of said event data, said selecting based on a stored preference of said recipient to receive said first message on said first notification channel at a designated time period;
generating said first message in a format suitable for sending over said first notification channel;
selecting from said plurality of electronic notification channels, a second notification channel over which to send a second message to said recipient, said second message including a second portion of said event data; and
generating said second message in a format suitable for sending over said second notification channel.

18. The method as in claim 17, comprising including in said first message an indication that said second portion of said event data is included in said second message.

19. A system comprising a processor to:
receive event data;
select from a plurality of electronic notification channels, a notification channel over which to send a message to a recipient, said message including at least a portion of said event data, wherein said processor selects said notification channel based on a stored preference of said recipient to receive said message on said notification channel at a designated time period; and
generate said message in a format suitable for sending over said notification channel, said message including a response option to said event data.

20. The system as in claim 19, wherein said processor is to select based on a schedule having a plurality of time periods and a preferred notification channel associated with a time period of said plurality of time periods.

21. The system as in claim 19, wherein said processor is to receive a signal from an indicator of an availability of said recipient by said notification channel at said designated time period.

22. The system as in claim 21, wherein said indicator is selected from the group consisting of a computerized calendar of said recipient, contemporaneous computer use by said recipient, contemporaneous use of an electronic device linked to a network, and an activation status of a screen saver on a computer of said recipient.

23. The system as in claim 19, including a memory to:
store said event data prior to said designated time period; and
wherein said processor is to deliver said event data during said designated time period.

24. The system as in claim 19, wherein said processor is to:
select a second notification channel over which to send said message to said recipient if a response is not received from said recipient within a pre-defined response time period; and
generate said message in a format suitable for said second notification channel.

25. The system as in claim 19, wherein processor is to include in said message a link to background information relevant to said event data.

26. The system as in claim 19, wherein said processor is to select said notification channel based on a characteristic of said event data.

27. The system as in claim 19, wherein said processor is to select a second recipient to receive a second message if no response to said message is received in a pre-defined response time period.
